(19) United States
(12) Patent Application Publication
(10) Pub. No.: US 2003/0223562 A1
(43) Pub. Date: Dec. 4, 2003

(54) Facilitating conference calls by dynamically determining information streams to be received by a mixing unit

(76) Inventors: Chenglin Cui, Succasunna, NJ (US); Kai X. Miao, Boonton Twp, NJ (US)

Correspondence Address: BUCKLEY, MASCHOFF, TALWALKAR, & ALLISON, 5 ELM STREET, NEW CANAAN, CT, 06840, US

(21) Appl. No.: 10/157,570

(22) Filed: May 29, 2002

(51) Int. Cl. H04M 3/42

(52) U.S. Cl. 379/202.01

(57) ABSTRACT

According to some embodiments, a conference call is facilitated by dynamically determining information streams to be received by a mixing unit.

### BACKGROUND

A telephone conference call lets multiple people communicate with each other. For example, ten people may place telephone calls to a conferencing server. The conference server then arranges for the people to speak with each other (i.e., a person provides audio information to everyone else when he or she speaks and receives audio information when others speak).

FIG. 1 is a block diagram of a known “matrix mixing” implementation of a conferencing server 100. As can be seen, each participant in the conference call is associated with a mixing unit 110 that receives audio information (e.g., audio “streams”) from, and provides audio streams to, a different mixing unit 110 for every other participant in the conference call. In particular, each mixing unit 110 combines (“+”) streams received from every other mixing unit 110. The matrix mixing approach, however, may cause problems when a conference call includes a large number of participants. For example, a conference call that includes one hundred participants would need one hundred mixing units 110, which represents a significant amount of processing resources. Moreover, each mixing unit 110 needs to receive and combine ninety nine input audio streams and the required data Input Output (IO) and processing resources may make the system impractical. For example, the total number of IO ports that can be supported by a single mixing unit 110 is generally limited. As a result, the matrix mixing approach has poor density scalability.

To overcome these problems, FIG. 2 is a block diagram of a known “group mixing” implementation of a telephone conference call system 200. In this case, participants in a conference call are divided into groups 210 (e.g., three participants may be associated with each group). Within a group 210, audio streams are exchanged between a group mixer 214 and each participant associated with that group (e.g., via a front end 212 processing application). Each group mixer 214 also exchanges audio streams with a center mixer 220. In this way, participants in one group 210 can exchange audio streams with participants in other groups 210. Moreover, different groups 210 can be associated with different processors (e.g., three different processors can be used to support three groups 210).

Even with the group mixing approach, however, multiple mixing units are required to support a conference call because of IO and processing resource limitations. In the example illustrated in FIG. 2, eight participants are supported via three group mixers 214 and one center mixer 220. Moreover, an audio stream may need to pass through three different mixers between participants (e.g., through a first group's mixer 214, then through the center mixer 220, and finally through a second group's mixer 210). Note that delays caused by the group mixing approach may vary between participants (e.g., a participant may experience a smaller delay when listening to someone within his or her group 210 and a longer delay when listening to someone outside that group 210). These delays can reduce the quality of a conference call.

### BRIEF DESCRIPTION OF THE DRAWINGS

FIG. 1 is a block diagram of a known matrix mixing implementation of a conferencing server.

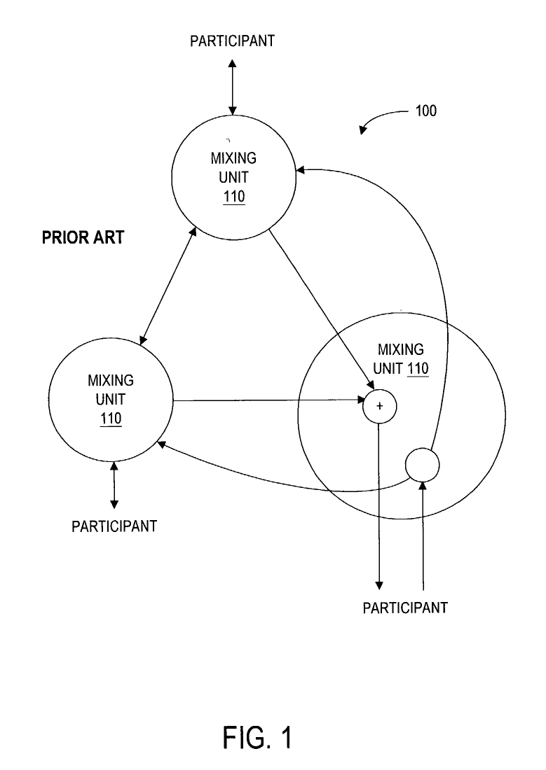

FIG. 2 is a block diagram of a known group mixing implementation of a telephone conference call system.

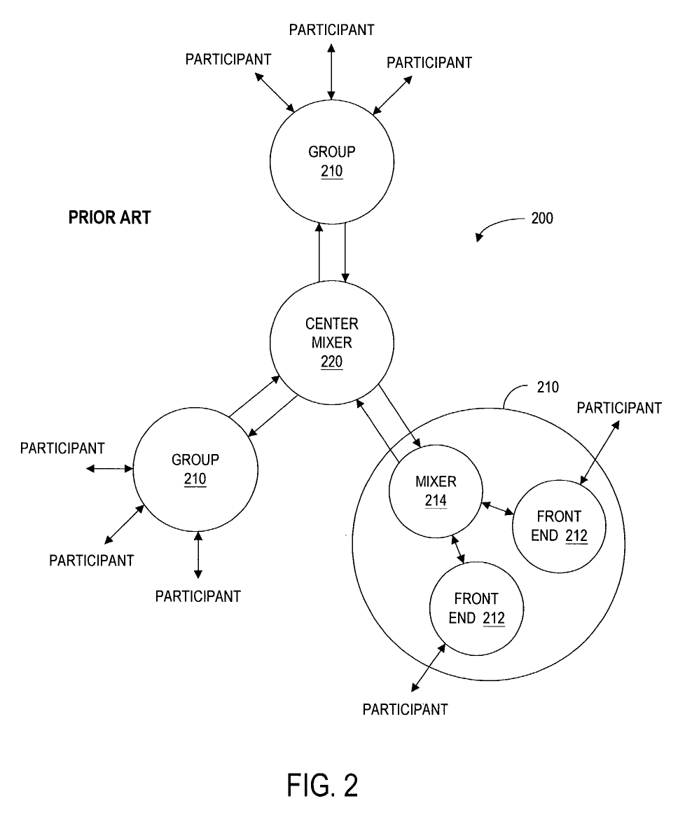

FIG. 3 is a flow chart of a method of facilitating conference calls according to some embodiments.

FIG. 4 is conference call system according to some embodiments.

FIG. 5 is conferencing server according to some embodiments.

FIG. 6 illustrates a portion of a participant database according to some embodiments.

FIG. 7 illustrates a portion of a conference call database according to some embodiments.

FIG. 8 is a block diagram of a telephone conference call system according to some embodiments.

FIG. 9 is a flow chart of a computer-implemented method of facilitating telephone conference calls according to some embodiments.

### DETAILED DESCRIPTION

Some embodiments described herein are associated with “conference calls.” As used herein, the phrase “conference call” may refer to any situation wherein multiple participants exchange streams of information with each other. For example, a conference call might comprise a telephone conference call that includes a number of participants who exchange audio streams. A conference call may also comprise a video conference call (e.g., including participants who exchange audio and image streams) or a conference conducted via an Internet conferencing server.

Moreover, as used herein, the term “participant” may refer to any person who exchanges information during a conference call. Note that the term “participant” includes a person who can receive information from—but cannot provide information to—other participants during a conference call (e.g., a person who can listen but whose speech will not be heard by other participants). A participant may also be a person who will exchange information during a future conference call. Moreover, a participant may be a communication device (e.g., a telephone) associated with a such a person.

Conference Call Method

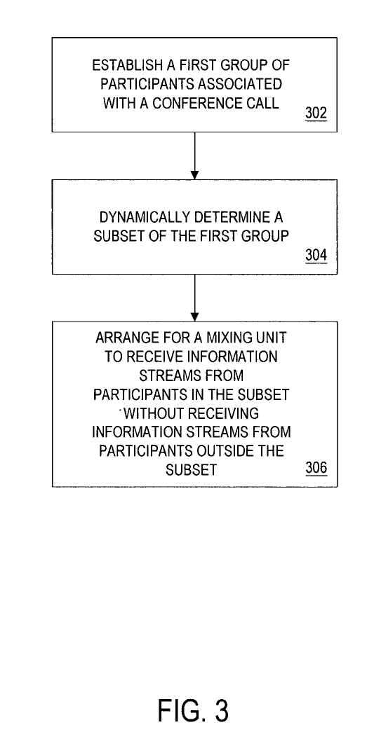

Turning now in detail to the drawings, FIG. 3 is a flow chart of a method of facilitating conference calls according to some embodiments. The flow charts in FIG. 3 and the other figures described herein do not imply a fixed order to the steps, and embodiments can be practiced in any order that is practicable.

At 302, a first group of participants associated with a conference call is established. In particular, these participants will receive information streams and potentially provide information streams to be included in a conference call.

At 304, a subset of the first group is dynamically determined. In particular, information streams from participants who are in the subset will be included in the conference call while information streams from participants who are not in the subset will not be included. For example, all participants in the first group may be monitored and information streams associated with only a limited number of “active” speakers (e.g., five participants) might be included in the subset.

At 306, it is arranged for a mixing unit to receive information streams from participants in the subset without receiving information streams from participants outside the subset. For example, the mixing unit may include IO ports associated with participants who are in the subset and at least one output port associated with participants who are not in the subset.

According to some embodiments, a switching matrix is provided between all of the participants in the first group and the mixing unit. That is, the switching matrix may have a number of ports associated with participants in the first group, and a lesser number of ports associated with the mixing unit (e.g., via mixing unit IO ports). For example, the switching matrix might be adapted to receive information streams from fifty participants in the first group and to route any five of those streams to one of five mixing unit IO ports (i.e., the five information streams from the five members in the subset).

The mixing unit may then combine the received information streams and provide combined information streams to participants as appropriate. For example, each participant in the subset may receive an information stream representing a combination of streams from every other participant in the subset (i.e., without including his or her own speech). Note that the mixing unit may also include at least one output port that provides a combined information stream to participants who are not in the subset (i.e., representing combined speech from all of the participants in the subset).

By flexibly routing information streams from a larger number of participants to a smaller number of mixing unit IO ports via a switching matrix, a single mixing unit can be used to support a large conference call. That is, a mixing unit having a limited number of IO ports can support a conference call that includes a much larger number of participants.

According to some embodiments, a second group of participants is also established. Participants in the second group will receive information streams but never provide information streams to the mixing unit. For example, participants in the second group may be able to listen, but not speak, during a telephone conference call.

The first and second groups may be established, for example, before the start of a conference call by an operator associated with a conference call service (e.g., the operator might assign certain participants to the first group and other participants to the second group). According to another embodiment, the groups are automatically established (e.g., by a conferencing server based on pre-determined information associated with the participants). According to still another embodiment, the groups are established by the participants themselves. For example, a participant might dial a first telephone number to be included in the first group or a second telephone number to be included in the second group. As another example, a participant might select a group using a Dual Tone-Multi Frequency (DTMF) command (e.g., by pressing “#1 ” on his or her telephone to be included in the first group).

According to other embodiments, all participants (i.e., including those in the second group as well as the first group) are dynamically monitored to determine if any participants should be moved between the first and second groups. For example, if it is detected that a participant in the second group is trying to speak, he or she might be moved into the first group (e.g., allowing his or her speech to be included in the conference call).

According to some embodiments, this also requires that another participant in the first group be “demoted” to the second group. For example, when the first group is limited to a pre-determined number of participants (e.g., based on a limited switching matrix capacity), the participant in the first group who has spoken the least during the conference call (or during the previous five minutes) might be demoted to make room for the new speaker. According to yet another embodiment, participants in a conference call are dynamically monitored to determine an appropriate number of participants that should be—or need to be—included in the first (or second) group.

The determination to move a participant between groups (or within a group, such as a determination of a subset of participants within the first group) may be based on information received during the conference call. For example, the determination might be based on information received from a participant (e.g., via a DTMF or speech recognition command), an active speech detector, and/or an operator.

According to some embodiments, a third group of participants is established in addition to the first and second groups. In particular, participants in the third group will always provide information streams to the mixing unit. Note that participants in this third group do not need to be monitored or participate in the switching process. As a result, an information stream from a participant in the third group may always be included in the conference call (i.e., even if the participant is not currently speaking). Note that participants might be initially assigned to the third group, or moved into or out of the third group, in any of the ways described above with respect to the first and second groups.

Conference Call System

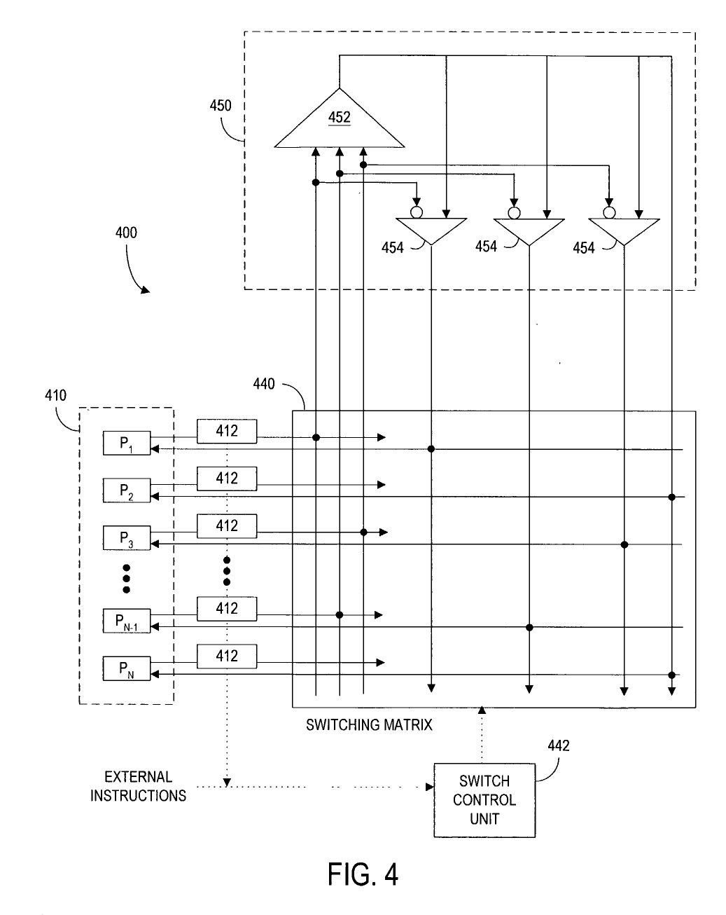

FIG. 4 is conference call system 400 according to some embodiments. The system 400 may be used, for example, to conduct a conference call as described with respect to FIG. 3.

In particular, the system 400 includes participants in a first group 410 (i.e., P₁ through P_{N}) who may, or may not, provide information streams to a mixing unit 450. Information streams generated by each participant (e.g., when he or she speaks into a telephone) are transmitted to a switching matrix 440. The switching matrix 440 may be used, for example, to select which information streams will be routed to the mixing unit 450. That is, the switching matrix 440 may route an information stream from a participant to a mixing resource 452 that combines multiple information streams into a single information stream. As illustrated in FIG. 4, information streams generated by P₁, P₃, and P_{N-1} are being routed to the mixing resource 452 (and information streams from P₂ and P_{N} are not). Note that the information stream from P₁ is also used by a self-subtracting resource 454 (i.e., so that P₁ does not hear his or her own speech through the conference call).

Active speech detectors 412, such as resources implemented via Digital Signal Processors (DSPs), monitor information streams generated by the participants (e.g., to detect who is currently speaking based on signal energy levels). The active speech detectors 412 provide this information to a switch control unit 442 (e.g., via a signal control message) that in turn manages the switching matrix 440. For example, the switch control unit 442 might manage the switching matrix 440 in accordance with the Enterprise Computer Telephony Forum (ECTF) H.100 Hardware Compatibility Specification Revision 1.0 (1997).

In this way, the system 400 can arrange for information streams associated with participants who are currently speaking to be routed to the mixing resource 452 (i.e., and included in the combined information streams). In other words, the participants in the first group 410 are dynamically monitored (e.g., by the active speech detectors 412) to determine which information streams will be included in the conference call.

Conferencing Server

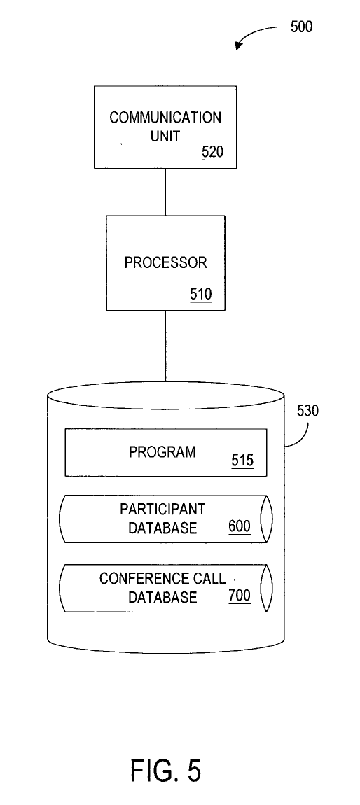

FIG. 5 illustrates a conferencing server 500 that may be associated with, for example, the conference call system of FIG. 4 according to some embodiments. The conferencing server 500 includes a processor 510, such as one or more INTEL® PENTIUM® processors. The processor 510 is coupled to a communication unit 520 which may be adapted to communicate with, for example, participants, active speech detectors, mixing units, switch control units, a switching matrix, and/or other processors. According to some embodiments, the processor 510 is also coupled to an input unit (not shown in FIG. 5). The input unit may comprise, for example, a computer keyboard or pointing device that an operator can use to establish or adjust groups of participants (e.g., by designating those participants who are most likely to speak during a conference call).

The processor 510 is also in communication with a storage device 530. The storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 530 stores a program 515 for controlling the processor 510 (i.e., the processor 510 performs instructions of the program 515). For example, the processor 510 may establish a first group of participants associated with a conference call. The processor 510 may then dynamically determine a subset of the first group and arrange for a mixing unit to receive information streams from participants in the subset without receiving information streams from participants outside the subset. According to some embodiments, the processor 510 also establishes a second group of participants who do not provide information streams to the mixing unit. Similarly, according to some embodiments, the processor 510 establishes a third group of participants who always provide information streams to the mixing unit. Note that the processor 510 might establish the third group without establishing the second group.

As used herein, information may be “received” by or “transmitted” to a software application or module within the conferencing server 500 from: (i) another device or (ii) another software application or module within the conferencing server 500.

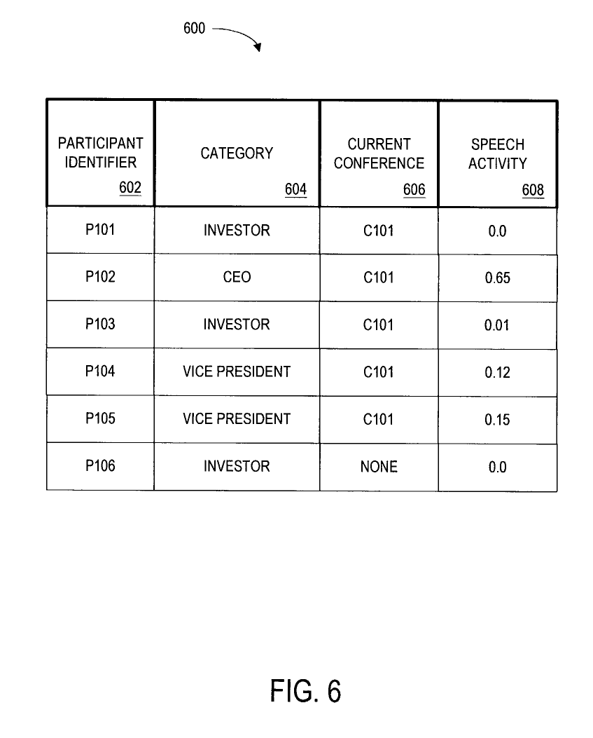

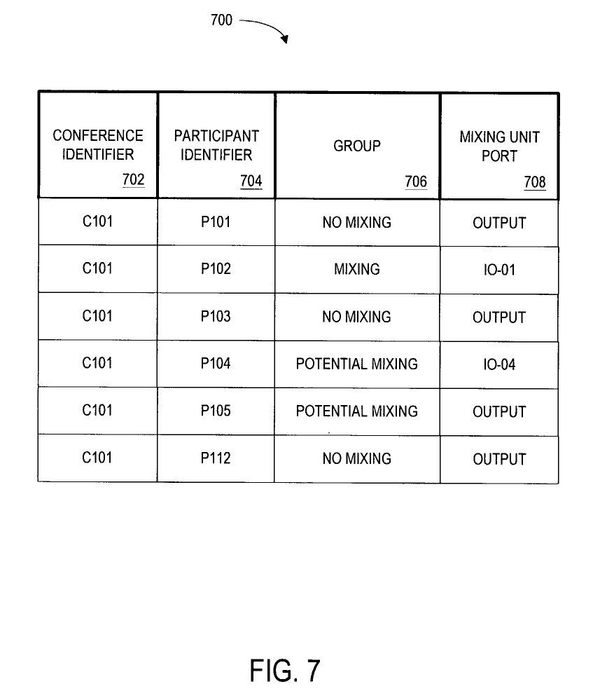

As shown in FIG. 5, the storage device 530 also stores a participant database 600 described with respect to FIG. 6) and a conference call database 700 (described with respect to FIG. 7). The illustrations and accompanying descriptions of the databases presented herein are exemplary, and any number of other database arrangements could be employed besides those suggested by the figures.

Participant Database

Referring to FIG. 6, a table represents the participant database 600 that may be stored at the conferencing server 500 according to one embodiment. The table includes entries identifying people who are participating (or may participate) in telephone conference calls. The table also defines fields 602, 604, 606, 608 for each of the entries. The fields specify: a participant identifier 602, a category 604, a current conference 606, and speech activity 608. The information in the participant database 600 may be created and updated, for example, based on information received from participants, operators, and/or active speech detectors.

The participant identifier 602 may be, for example, an alphanumeric code associated with a person who is participating (or may participate) in a conference call. The participant identifier 602 may be generated by, for example, the conferencing server 500, the participant (e.g., when he or she supplies a user name and password), and/or an external device (e.g., a caller identification device).

The category 604 represents information about the participant. In the example illustrated in FIG. 6, the category represents a type of person who may participate in an investor conference call (e.g., a “vice president” or an “investor”). The current conference 606 may be, for example, an alphanumeric code associated with a conference call in which the participant is currently participating. The speech activity 608 may be a value associated with, for example, the amount of time the participant speaks during a conference call (e.g., a current conference call or one or more prior conference calls).

Conference Call Database

Referring to FIG. 7, a table represents the conference call database 700 that may be stored at the conferencing server 500 according to one embodiment. The table includes entries identifying current conference calls. The table also defines fields 702, 704, 706, 708 for each of the entries. The fields specify: a conference identifier 702, a participant identifier 704, a group 706, and a mixing unit port 708. The information in the conference call database 700 may be created and updated, for example, based on information received from participants, operators, and/or active speech detectors.

The conference identifier 702 may be an alphanumeric code associated with a particular conference call and may be based on, or associated with, the current conference 606 stored in the participant database 600. The participant identifier 704 may be an alphanumeric code associated with a particular participant in the conference call and may be based on, or associated with, the participant identifier 602 stored in the participant database 600.

The group 706 represents a conference call group associated with the participant. For example, the group 706 might indicate that his or her information stream will be: (i) dynamically monitored to determine it will be routed to a mixing unit via a switching matrix (“potential mixing”), never provided to a mixing unit (“no mixing”), or always provide to a mixing unit (“mixing”).

The mixing unit port 708 may be associated with, for example, a particular IO port or an output port of a mixing unit (e.g., each “mixing” participant may be associated with a particular IO port, each “no mixing” participant may be associated with the output port, and each “potential mixing” participant might be associated with either a particular IO port or the output port).

Example

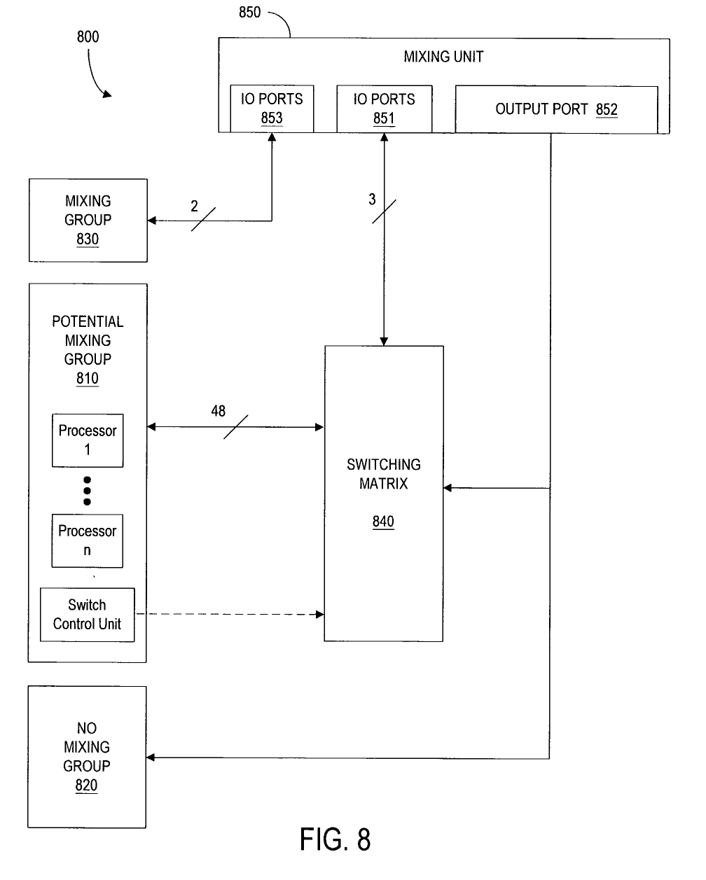

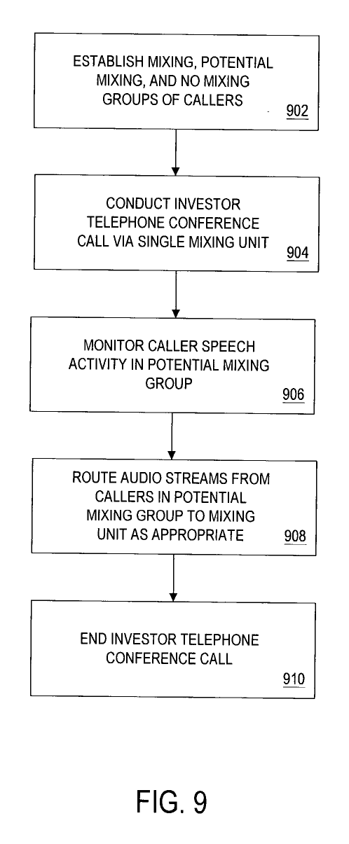

FIG. 8 is a block diagram of a telephone conference call system 800 according to some embodiments. The system 800 may be used, for example, to establish groups and to conduct a telephone conference call for investors in accordance with the method illustrated in FIG. 9.

The conference call might be initiated, for example, when several hundred callers place telephone calls that are handled by a Computer Telephony (CT) server, a Private Branch Exchange (PBX), or a public switch. The conference call may supported by, for example, a product (e.g., an INTEL® Converged Communications Platform) or a service provider (e.g., an AT&T® conference call service). Moreover, the conference call might be supported via a Time-Division Multiplexing (TDM) bus, an Asynchronous Transfer Mode (ATM) circuit, a Real-time Transport Protocol (RTP) circuit, and/or the Session Initiation Protocol (SIP) described in the Internet Engineering Task Force (IETF) Request for Comments 2543 (March 1999).

The callers might participate in the telephone conference call by using “communication devices.” As used herein, the phrase “communication device” may refer to any device that lets a person exchange information with another person via a communication network. Examples of communication devices include wired or wireless telephones, computers adapted to provide telephone communication, and hardware units (e.g., boards) or software applications that enable a computer to provide telephone communication. For example, a communication device might be a Personal Computer (PC) with one or more INTEL® DIALOGIC® telecom boards that incorporate Interactive Voice Response (IVR) capabilities.

Moreover, the callers may participate in the telephone conference call through one or more “communication networks.” As used herein, the phrase “communication network” may refer to, for example, a telephone network such as a Public Switched Telephone Network (PSTN), a wireless network, or a network associated with a PBX device. A communication network may also be a Local Area Network (LAN), a Metropolitan Area Network (MAN), a Wide Area Network (WAN), a proprietary network, a Wireless Application Protocol (WAP) network, and/or an Internet Protocol (IP) network such as the Internet, an intranet or an extranet. Note that a communication network may include a number of different networks.

Referring now to FIGS. 8 and 9, a conferencing server 500 establishes groups of callers at 902. For example, the conferencing server 500 might access information in a participant database 600 to determine which callers will be placed in a “potential mixing” group 810 (e.g., callers who have a category 604 of “vice president” or a speech activity 608 value between 0.10 and 0.40 might be assigned to the potential mixing group 810). The conferencing server 500 may also establish a “no mixing” group 820 (e.g., callers who have a category 604 of “investor” and a speech activity 608 value below 0.10 might be assigned to the no mixing group 820) and a “mixing group” 830 (e.g., callers who have a category 604 of “CEO” or a speech activity 608 value above 0.40 might be assigned to the mixing group).

The conference call database 700 may then be updated with the appropriate participant identifiers 704 and associated groups 706. The conferencing server 500 may also assign a mixing unit port 708 to each caller. The mixing unit port 708 may be associated with, for example, an IO port 851 that is reserved for the potential mixing group 810. Similarly, the mixing unit port 708 might be an output port 852 (i.e., used by both the potential mixing group 810 an the no mixing group 820), or an IO port 853 reserved for the mixing group 830.

At 904, the investor telephone conference call is conducted via a single mixing unit 850 (e.g., having a single processor). In particular, the mixing unit 850 is adapted to combine audio streams received via the IO ports 851, 853 and to provide output audio streams via the IO ports 851, 853 and the output port 852.

At 906, processors 1 through n and a switch control unit determine which callers in the potential mixing group 810 are currently speaking. At 908, audio streams from those callers (i.e., the “subset” of callers described with respect to FIG. 3) are routed to the mixing unit 850 through the switching matrix 840. Note that all of the participants in the potential mixing group 810 receive audio streams from the mixing unit 850 (i.e., participants in the subset receive streams via the IO ports 851 and participants outside the subset receive streams via the output port 852).

Audio streams from the callers in the no mixing group 820 are not provided to the mixing unit 850. These callers do, however, receive audio streams via the output port 852. Finally, audio streams from the mixing group 830 are always routed to the appropriate IO ports 853 of the mixing unit 850. The conferencing server 500 may also adjust the speech activity 610 value in the participant database 600 and/or the group 706 and associated mixing unit port 708 in the conference call database 700 as appropriate.

In this way, the system 800 may handle a large number of callers using a single mixing unit 850 (e.g., because many of the callers in the potential mixing group 810 do not require a dedicated IO port). In particular, the mixing unit 850 illustrated in FIG. 8 has only five IO ports, including two IO ports 853 reserved for the mixing group 830 and three IO ports 851 reserved for the potential mixing group 810. The switching matrix 840, however, can route audio streams from any three of the forty eight callers in the potential mixing group 810 to the three associated IO ports 851. Thus, the single mixing unit 850 can support up to fifty callers who might speak during the conference call (i.e., two in the mixing group 830 and forty eight in the potential mixing group). In addition, any number of additional callers in the no mixing group 820 can receive audio streams via the output port 852.

Moreover, multiple processors can be used to support the conference call (e.g., by monitoring caller speech activity and controlling the switching matrix 840) without having to combine audio streams. Referring again to FIG. 4, the active speech detectors 412 and/or the switch control unit 442 might be embedded in any number of processors (e.g., these tasks that are easily divisible among multiple processors) while a single processor is associated with the mixing unit 450. In this way, the system 400 uses the switching matrix 440 to support a large number of participants with resources distributed among different processors - without needing to establish mixing units on multiple processors. This approach may be more scalable than traditional conferencing implementations.

The investor telephone conference call then ends at 910. According to other embodiments, active speech detectors are also provided for callers in the no mixing group 820 and the mixing group 830 (e.g., to let the system 800 monitor all callers and move them between groups 810, 820, 830 as appropriate). According to some embodiments, participants in the potential mixing group 810 and the mixing group 830 are associated with a single device or processor (e.g., to reduce the need to switch between processors). Moreover, although a particular number of callers are illustrated in FIG. 8, any number of callers could be included in each group 810, 820, 830. Similarly, the mixing unit 850 could have any number of IO ports.

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some embodiments have been described with respect to a conference call supported by a single mixing unit, multiple mixing units (and/or multiple switch fabrics) may also be, used. For example, a first mixing unit and switching matrix could support participants in one region while another mixing unit and switching matrix support participants in another region (e.g., and the two mixing units may exchange combined streams as necessary). As another example, a single switching matrix could provide information streams to two mixing units (or two switching matrixes could provide information streams to a single mixing unit).

Similarly, although some embodiments have been described with respect to three groups of participants, other numbers of groups may also be used. For example, two or four groups of participants may be established by a conferencing server 500 (e.g., “mixing,” “highly likely mixing,” “less likely mixing,” and “no mixing”).

The several embodiments described herein are solely for the purpose of illustration. Persons skilled in the art will recognize from this description other embodiments may be practiced with modifications and alterations limited only by the claims.

What is claimed is:

1. A method of facilitating conference calls, comprising:
establishing a first group of participants associated with a conference call;
dynamically determining a subset of the first group; and
arranging for a mixing unit to receive information streams from participants in the subset without receiving information streams from participants outside the subset.

2. The method of claim 1, further comprising:
providing information streams to the first group of participants based on an output of the mixing unit.

3. The method of claim 1, wherein the conference call is conducted via a single mixing unit.

4. The method of claim 3, wherein the mixing unit includes: (i) input output ports associated with participants in the subset, and (ii) at least one output port associated with participants outside the subset.

5. The method of claim 1, wherein said arranging is performed via a switching matrix that includes:
a first number of ports associated with participants in the first group; and
a second number of ports associated with mixing unit input output ports, wherein the second number is less than the first number.

6. The method of claim 5, wherein said arranging is further performed via a switch control unit adapted to couple at least some of the first number of ports with at least some of the second number of ports.

7. The method of claim 1, further comprising:
dynamically monitoring participants in the first group to determine if a participant will be included in the subset.

8. The method of claim 7, wherein said monitoring is based on information received at least one of: (i) during the conference call, (ii) from a participant, (iii) via an active speech detector, (iv) via a dual tone multi-frequency command, (v) via a speech recognition command, and (vi) from an operator.

9. The method of claim 1, further comprising:
establishing a second group of participants who will not provide information streams to the mixing unit.

10. The method of claim 9, further comprising:
dynamically monitoring participants to determine if a participant should be moved between the first and second groups.

11. The method of claim 9, further comprising:
dynamically monitoring participants to determine a total number of participants to be included in at least one of the first group, the subset of the first group, and the second group.

12. The method of claim 9, wherein said establishing is based on at least one of: (i) information determined prior to the conference call, (ii) information received from a participant, and (iii) information received from an operator.

13. The method of claim 1, further comprising:
establishing a third group of participants who will provide information streams to the mixing unit.

14. The method of claim 1, wherein the conference call comprises a telephone conference call conduced via a communication network and the information streams comprise audio streams.

15. The method of claim 14, wherein the communication network includes at least one of: (i) a public switched telephone network, (ii) an Internet protocol network, (iii) the Internet, (iv) an intranet, (v) a wireless network, and (vi) a proprietary network.

16. A conferencing server, comprising:
a processor; and
a storage device adapted to communicate with said processor and storing instructions adapted to be executed by said processor to:
establish a first group of participants associated with a conference call,
dynamically determine a subset of the first group, and
arrange for a mixing unit to receive information streams from participants in the subset without receiving information streams from participants outside the subset.

17. The conferencing server of claim 16, wherein said processor is further adapted to communicate with at least one of: (i) a telephone, (ii) a switch matrix, (iii) an information stream mixing unit, and (iv) at least one switch control unit.

18. The conferencing server of claim 16, wherein said storage device further stores at least one of: (i) a participant database, and (ii) a conference call database.

19. A medium storing instructions adapted to be executed by a processor to perform a method of facilitating conference calls, said method comprising:
establishing a first group of participants associated with a conference call;
dynamically determining a subset of the first group; and
arranging for a mixing unit to receive information streams from participants in the subset without receiving information streams from participants outside the subset.

20. The medium of claim 19, wherein said method further comprises:
arranging for the conference call to be conducted using a single mixing unit.

21. A conference call system, comprising:
a mixing unit, including:
a set of input output ports associated with a subset of a group of conference call participants,
at least one output port associated with participants who are outside the subset, and
a processor adapted to mix information streams received via the set of input output ports and to provide mixed information streams via both the set of input output ports and the output port; and
a switching matrix, including:
a first number of ports adapted to receive information streams from the participants; and
a second number of ports adapted to provide information to the mixing unit input output ports, wherein the second number is less than the first number.

22. The conference call system of claim 21, wherein the switching matrix is controlled by a switch control unit.
